(19) United States
(12) Patent Application Publication
(10) Pub. No.: US 2017/0010640 A1
(43) Pub. Date: Jan. 12, 2017

(54) MOUNTING APPARATUS FOR DATA STORAGE DEVICE AND ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: JIE YANG, Shenzhen (CN); JUN-XIONG ZHANG, Shenzhen (CN)

(73) Assignee: HON HAI PRECISION INDUSTRY CO., LTD., New Taipei (TW)

(21) Appl. No.: 14/793,948

(22) Filed: Jul. 8, 2015

(51) Int. Cl. G06F 1/18

(52) U.S. Cl. CPC G06F 1/187; G06F 1/182

(57) ABSTRACT

A mounting apparatus for fixing a data storage device to a bottom plate includes a receiving frame for receiving the data storage device having a number of hooks extending from a bottom of the receiving frame, a supporting member configured to be fixed to the bottom plate and support the receiving frame, a sliding member slidably coupled to the supporting member and defining a number of through holes for the hooks extending through and having a number of latching tabs extending down from inside walls of the sliding member bounding the through holes, and an elastic member capable of restoring the sliding member. Wherein the hooks urge against the latching tabs to slide the sliding member to deform the elastic member, when the hooks slide over the latching tabs, the elastic member elastically recovers making the hooks hook the latching tabs.

### FIELD

The subject matter herein generally relates to a mounting apparatus and an electronic device.

### BACKGROUND

Data storage devices, such as hard disk drives (HDDs), are generally mounted in a server with a number of screws.

### BRIEF DESCRIPTION OF THE DRAWINGS

Implementations of the present technology will now be described, by way of example only, with reference to the attached figures.

FIG. 1 is an exploded, isometric view of an embodiment of an electronic device.

FIG. 2 is an exploded, isometric view of a receiving frame and a sliding member of the electronic device of FIG. 1.

FIG. 3 is an assembled, isometric view of FIG. 1, wherein a mounting apparatus is locked.

FIG. 4 is a cross sectional view of FIG. 3 taken along line IV-IV.

FIG. 5 is similar to FIG. 4, wherein the mounting apparatus is unlocked.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “inside” indicates that at least a portion of a region is partially contained within a boundary formed by the object. The term “comprising” means “including, but not necessarily limited to”; it specifically indicates open-ended inclusion or membership in a so-described combination, group, series and the like.

The present disclosure is described in relation to an electronic device.

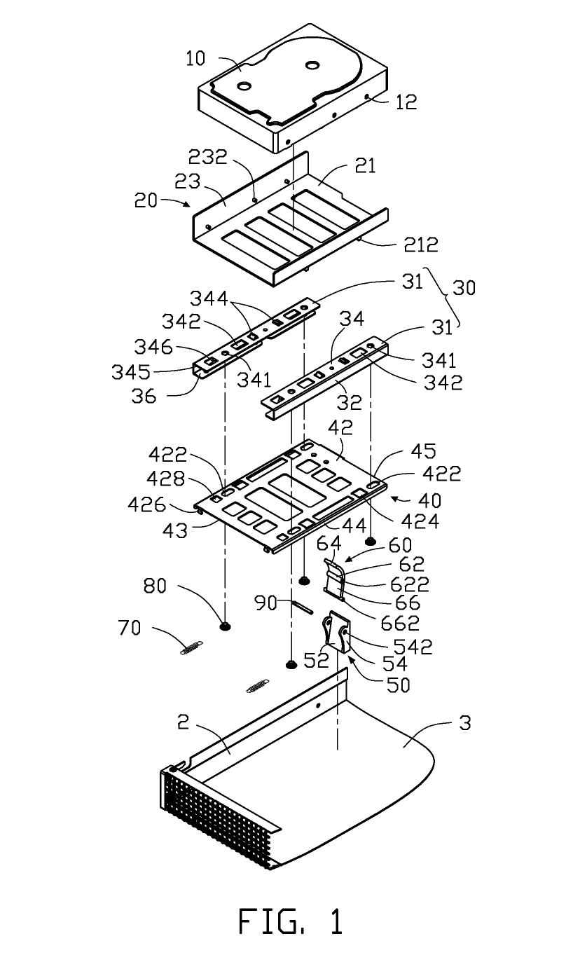

FIG. 1 illustrates an embodiment of an electronic device. The electronic device includes a mounting apparatus, a data storage device 10, and a chassis 2. The chassis 2 comprises a bottom plate 3. The mounting apparatus comprises an elastic receiving frame 20, a supporting member 30, a sliding member 40, a fixing bracket 50, a releasing member 60, and two elastic members 70. Three engaging holes 12 are defined in each of opposite sides of the data storage device 10. In at least one embodiment, the two elastic members 70 are coil springs. The data storage device 10 is a hard disk drive (HDD).

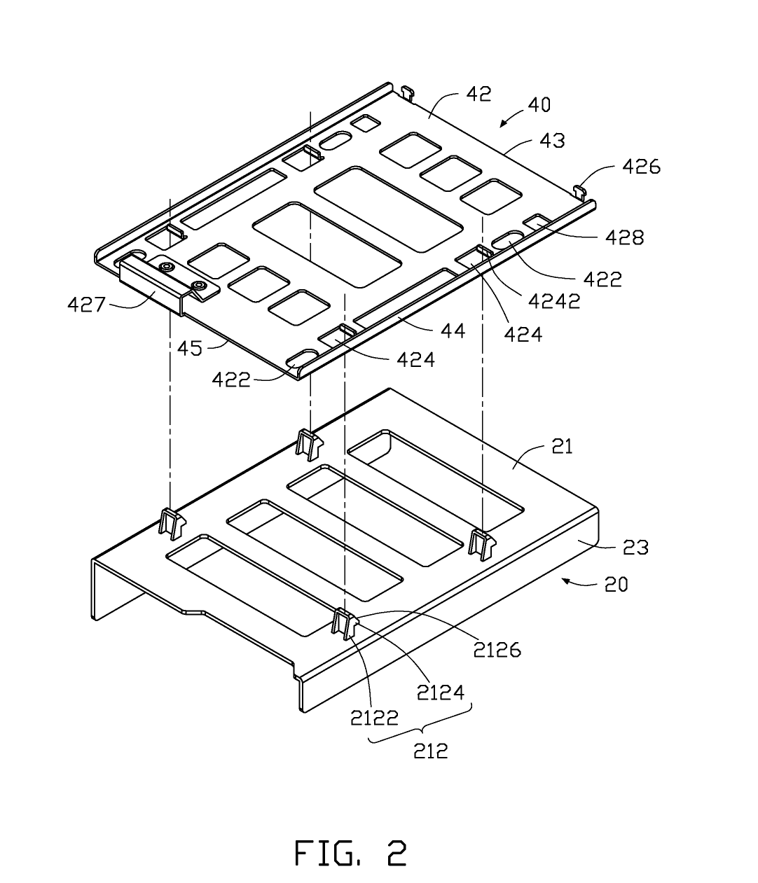

FIG. 2 further illustrates the receiving frame 20 and the sliding member 40. The receiving frame 20 comprises a base plate 21 and two side plates 23 perpendicularly extending up from opposite sides of the base plate 21. Four hooks 212 extend down from the base plate 21. Each hook 212 comprises an extending portion 2122 extending down from base plate 21 and a hooking portion 2124 extending sidewards from an end of the extending portion 2122 away from the base plate 21. Each hooking portion 2124 comprises a bevel 2126 against the base plate 21. Three engaging posts 232 extend from each side plate 23, facing the other side plate 23.

The supporting member 30 comprises two supporting brackets 31. Each supporting bracket 31 comprises a side wall 32. A top wall 34 and a bottom wall 36 extend from opposite sides of the side wall 32. The top wall 34 is parallel to the bottom wall 36. Two through holes 341 are defined near a front end 345 and a rear end of the top wall 34. Two through holes 342 are defined in the top wall 34 between the two through holes 341. Two elastic tabs 344 extend up from the top wall 34, located between the two through holes 342. A positioning tab 346 extends down from the top wall 34, near the front end 345.

The sliding member 40 comprises a base plate 42 and two flanges 44 extending down from opposite sides of the base plate 42. The base plate 42 comprises a front end 43 and a rear end 45. Two elongate grooves 422 are defined near the front end 43 and the rear end 45. Two through holes 424 are defined between the two grooves 422. A positioning hole 428 is defined between the two grooves 422. Two fixing tabs 426 extend down from the front end 43, near the two flanges 44. A driving portion 427 extends down from the rear end 45. A latching tab 4242 extends down from an inside wall of the base plate 42 bounding each through hole 424, near the front end 43.

The fixing bracket 50 comprises a main body 52 and two pivoting portions 54 extending from opposite sides of the main body 52. Each pivoting portion 54 defines a pivoting hole 542 facing the other pivoting portion 54.

The releasing member 60 comprises a shaft 62, an operating portion 64, and a pushing plate 66. The operating portion 64 extends up from a first side of a circumference of the shaft 62. The pushing plate 66 extends down from a second side of the circumference of the shaft 62 and is coupled to the operating portion 64. The shaft 62 axially defines a through hole 622. A pushing post 662 extends from an end of the pushing plate 66 away from the shaft 62.

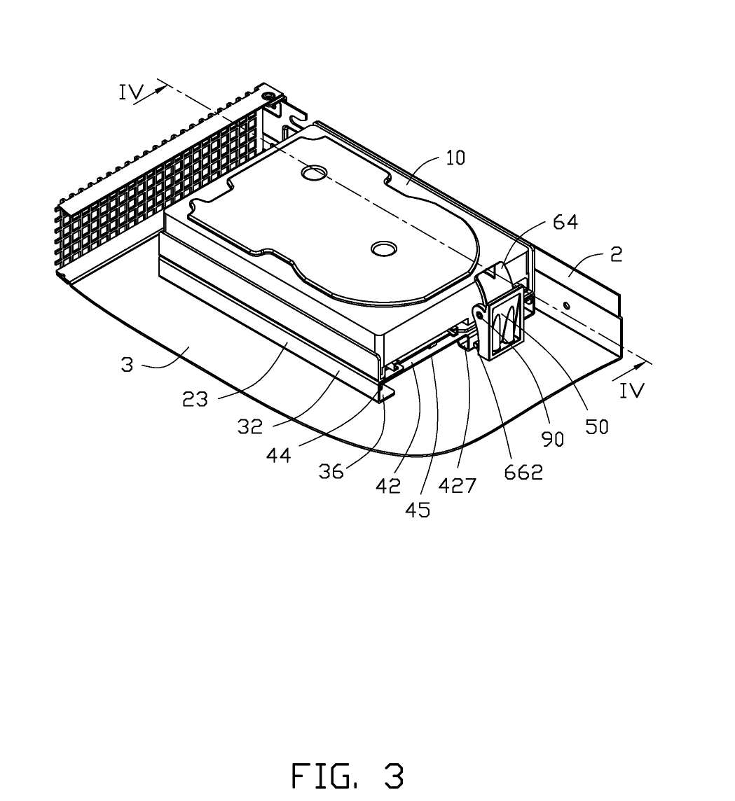

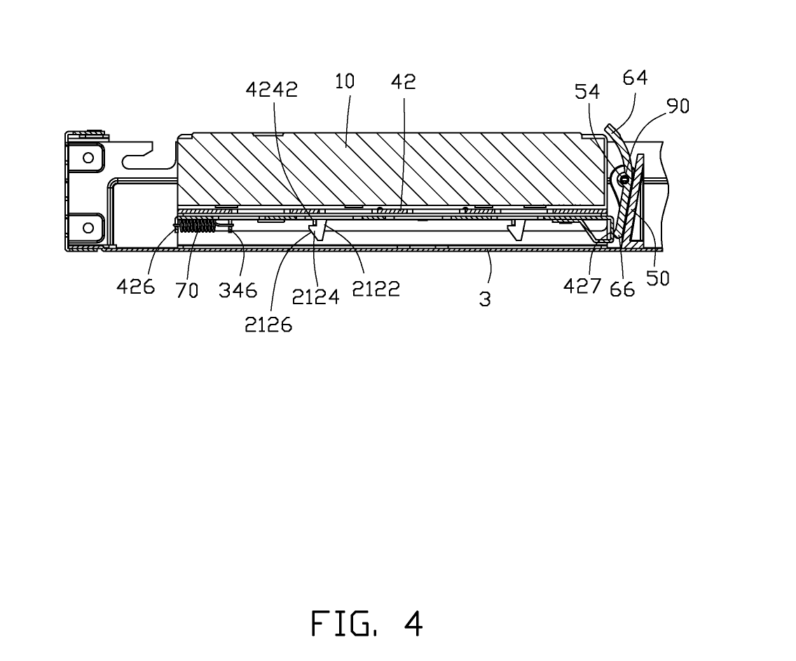

FIGS. 3 and 4 illustrate the mounting apparatus and the data storage device 10. In assembly of the mounting apparatus, the two supporting brackets 31 are symmetrically placed. The front end 43 of the base plate 42 is slid to the front ends 345 of the two top walls 34. The base plate 42 abuts against the two top walls 34. The two flanges 44 abut against the two side walls 32. The positioning tabs 346 of the two top walls 34 extend through the positioning holes 428 of the base plate 42. The through holes 341 of the two top walls 34 are aligned with the grooves 422 of the base plate 42. The through holes 342 of the two top walls 34 are aligned with the through holes 424 of the base plate 42. Four fixing posts 80 extend through the grooves 422 and the through holes 341 and are riveted and coupled to the two top walls 34. Thus, the sliding member 40 is slidably coupled to the two supporting brackets 31 and the two elastic members 70 are arranged between the two fixing tabs 426 and the two positioning tabs 346. The bottom walls 36 of the two supporting brackets 31 are attached to the bottom plate 3, attaching the supporting member 30 to the chassis 10. The shaft 62 is placed between the two pivoting portions 54, to align the through hole 622 with the two pivoting holes 542. A pin 90 extends through the through hole 622, with opposite ends of the pin 90 pivotably engaging with the two pivoting holes 542, to pivotably couple the releasing member 60 to the fixing bracket 50. The fixing bracket 50 is mounted to the bottom plate 3, near the rear end 45 of the base plate 42.

In assembly of the mounting apparatus and the data storage device 10, each side plate 23 is pulled against the other side plate 23 to place the data storage device 10 on the base plate 21. The two side plates 23 are released to engage the engaging posts 232 in the engaging holes 12 and abut against the opposite sides of the data storage device 10 to fix the data storage device 10 in the receiving frame 20. The receiving frame 20 with the data storage device 10 is arranged over the two supporting brackets 31 and moves down to make the bevels 2126 of the hooks 212 extend through the through holes 342 and slidably urge against the latching tabs 4242 of the base plate 42 moving the sliding member 40 away from the releasing member 60. The two elastic members 70 are elastically deformed. When the bevels 2126 are slid over the latching tabs 4242, the two elastic members 70 elastically recover to restore the sliding member 40. The latching tabs 4242 are hooked by the hooking portions 2124 of the hooks 212 and abut against the extending portions 2122 of the hooks 212. The base plate 21 compresses the elastic tabs 344 of the two top walls 34 to elastically deform the elastic tabs 344.

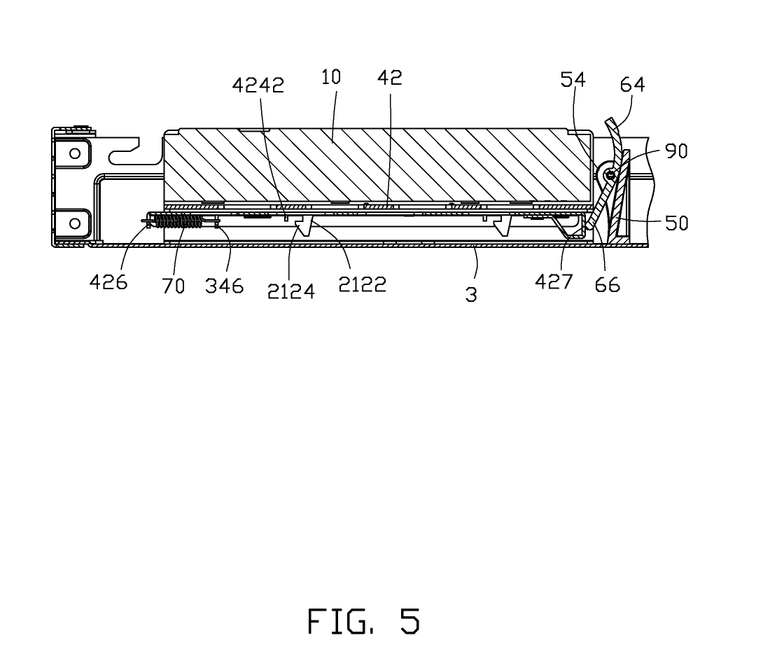

FIG. 5 illustrates in disassembly of the data storage device 10, the operating portion 64 of the releasing member 60 is rotated away from the sliding member 40 rotating the pushing plate 66 of the releasing member 60 toward the sliding member 40.

The pushing post 662 of the pushing plate 66 urges the driving portion 427 of the sliding member 40 to slide the sliding member 40 away from the fixing bracket 50. The latching tabs 4242 disengage from the hooks 212 to release the receiving frame 20. The elastic tabs 344 elastically recover to urge the base plate 21 to lift up the receiving frame 20 with the data storage device 10. The receiving frame 20 with the data storage device 10 is taken out, and then, the data storage device 10 is taken out of the receiving frame 20.

The embodiments shown and described above are only examples. Many details are often found in the art such as the other features of a mounting apparatus and an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A mounting apparatus for fixing a data storage device to a chassis, the mounting apparatus comprising:
a supporting member configured to be fixed to the chassis;
a sliding member slidably coupled to the supporting member, the sliding member defining a plurality of through holes and comprising a plurality of latching tabs;
a receiving frame for receiving the data storage device, the receiving frame comprising a plurality of hooks extending through the plurality of through holes and configured to move from a locking position to an unlocking position; and
at least one elastic member configured to restore the sliding member;
wherein in the locking position, the plurality of hooks is engaged with the plurality of latching tabs to prevent the receiving frame with the data storage device from moving away from the sliding member; and
wherein in the unlocking position, the sliding member is biased laterally to disengage the plurality of hooks from the plurality of latching tabs, and the receiving frame with the data storage device mounted thereto is configured to move away from the sliding member.

2. The mounting apparatus of claim 1, wherein the supporting member comprises two supporting brackets, each supporting bracket comprises a top wall, the two top walls define a plurality of through holes aligned with the plurality of through holes of the sliding member, and the plurality of hooks extends through the plurality of through holes of the two top walls.

3. The mounting apparatus of claim 2, wherein a plurality of elastic tabs is located on the two top walls to abut against the receiving frame.

4. The mounting apparatus of claim 2, wherein the sliding member further comprises a base plate abutting against the two top walls, a plurality of grooves is defined in the base plate, and a plurality of fixing posts extends through the plurality of grooves and is coupled to the two top walls.

5. The mounting apparatus of claim 4, wherein the sliding member further comprises two flanges located on the base plate, each supporting bracket further comprises a side wall, and the two flanges abut against the two side walls.

6. The mounting apparatus of claim 4, wherein the base plate comprises a front end and a rear end, the number of the at least one elastic member is two, two fixing tabs are located at the front end, two positioning holes are defined in the base plate near the front end, two positioning tabs extending through the two positioning holes are located on the two top walls, and the two elastic members are arranged between the two fixing tabs and the two positioning tabs.

7. The mounting apparatus of claim 4, further comprising an releasing member, wherein the releasing member is configured to urge the sliding member to slide for disengaging the latching tabs from the hooks.

8. The mounting apparatus of claim 7, further comprising a fixing bracket attached to the bottom plate, wherein the releasing member is pivotably coupled to the fixing bracket.

9. The mounting apparatus of claim 8, wherein the fixing bracket comprises a main body and two pivoting portions located on the main body, the releasing member comprises a shaft pivotably coupled between the two pivoting portions and a pushing plate located at a side of the shaft, and the pushing plate is configured to urge the sliding member.

10. The mounting apparatus of claim 1, wherein the receiving frame comprises a base plate for supporting the data storage device and two side plates located on the base plate for abutting against the data storage device.

11. The mounting apparatus of claim 10, wherein a plurality of engaging posts extends from the two side plates to engage with a plurality of engaging holes defined in the data storage device.

12. The mounting apparatus of claim 1, wherein each hook comprises an extending portion and a hooking portion coupled to the base plate, when the plurality of hooks slides over the plurality of latching tabs, the plurality of latching tabs is hooked by the hooking portions, and the plurality of latching tabs abuts against the extending portions.

13. The mounting apparatus of claim 12, wherein the hooking portion comprises a bevel configured to slidably urge a corresponding latching tab.

14. An electronic device comprising:
a chassis;
a supporting member fixed in the chassis;
a sliding member slidably coupled to the supporting member, the sliding member defining a plurality of through holes and comprising a plurality of latching tabs;
a data storage device;
a receiving frame to receive the data storage device, the receiving frame comprising a plurality of hooks extending through the plurality of through holes and configured to move from a locking position to an unlocking position; and
at least one elastic member configured to restore the sliding member;
wherein in the locking position, the plurality of hooks is engaged with the plurality of latching tabs to prevent the receiving frame with the data storage device from moving away from the sliding member; and
wherein in the unlocking position, the sliding member is biased laterally to disengage the plurality of hooks from the plurality of latching tabs, and the receiving frame with the data storage device mounted thereto is configured to move away from the sliding member.

15. The electronic device of claim 14, wherein the supporting member comprises two supporting brackets, each supporting bracket comprises a top wall, the two top walls define a plurality of through holes aligned with the plurality of through holes of the sliding member, and the plurality of hooks extends through the plurality of through holes of the two top walls.

16. The electronic device of claim 15, wherein a plurality of elastic tabs is located on the two top walls to abut against the receiving frame.

17. The electronic device of claim 15, wherein the sliding member further comprises a base plate abutting against the two top walls, a plurality of grooves is defined in the base plate, and a plurality of fixing posts extends through the plurality of grooves and is coupled to the two top walls.

18. The electronic device of claim 17, further comprising an releasing member, wherein the releasing member is configured to urge the sliding member to slide for disengaging the latching tabs from the hooks.

19. The electronic device of claim 18, further comprising a fixing bracket attached to the bottom plate, wherein the releasing member is pivotably coupled to the fixing bracket.
